(19) United States
(12) Patent Application Publication
(10) Pub. No.: US 2018/0206628 A1
(43) Pub. Date: Jul. 26, 2018

(54) METHOD AND APPARATUS FOR BRUSH SOAKING

(71) Applicant: James Sigmund, Hespiria, CA (US)

(72) Inventor: James Sigmund, Hespiria, CA (US)

(21) Appl. No.: 15/413,239

(22) Filed: Jan. 23, 2017

(51) Int. Cl. A46B 17/06; B44D 3/12; B65D 25/28; B65D 43/02; B65D 25/10; B08B 3/10

(52) U.S. Cl. CPC A46B 17/06; B44D 3/125; B08B 3/10; B65D 43/02; B65D 25/10; B65D 25/28

(57) ABSTRACT

An apparatus (10, 100) for soaking brushes (26) in a solvent (24) The apparatus includes a body (12) having a surface material (18) and a fill material (20). The body is sufficiently buoyant to float on the surface of the solvent, even when the apparatus holds at least one of the brushes. A number of holding stations (14) are provided in the body, that extend through the body of the apparatus, wherein each holding station includes a holding mechanism (38) that is suitable to retain one of the brushes in its respective holding station.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

### Technical Field

The present invention relates generally to supports: racks, and more particularly to devices having a structure which is designed to support a particular article consisting of a handle and working bristles (e.g., a paint brush).

### Background Art

Many professional and amateur seek to minimize the expense that painting entails. The main areas where this can be managed are in reducing the costs of the tools used and in increasing the efficiency of the labor required.

Of present interest, a tool widely used in painting is paint brushes. One typically gets what they pay for. Experienced painters know that one expensive brush may be better than a handful of cheap brushes. Good brushes can be cleaned and reused, and good brushes are robust and do not rapidly deteriorate and adversely affect the quality of the work being done.

The ability to clean and reuse paint brushes clearly reduces tool cost. Less obviously, it can also increase labor efficiency. To the extent that brushes can be reused longer, there is less labor inefficiency in having to procure new brushes. Counter balancing this, however, the cleaning of brushes can take appreciable time and effort, decreasing labor efficiency. Thus, while the general advice of brush manufactures is to clean paint brushes immediately after use, painters know that this can entail more labor, and they may opt for simply soaking brushes overnight and having less effort being able to use brushes again the next day.

Another widely used item in painting, viewable as a material or a “tool,” is brush cleaning solvents. The best solvent to use will largely be dictated by the type of paint being used. Water is commonly used to remove water based paints and glues; mineral spirits or paint thinners are used to remove oil based paints; denatured alcohol is used for shellacs; and mineral spirits are used for varnishes. All of these solvents evaporate to varying degrees. Water is relatively inexpensive, and making extra effort to minimizing its evaporation as a means to reduce solvent cost is rarely worthwhile. In contrast, all of the other solvents here are more expensive and minimizing their evaporation as a means to reduce solvent cost can be quite worthwhile. Moreover, worker exposure to these evaporated non-water solvents can be unhealthy and their presence can pose significant fire and explosion hazards.

Yet another widely used item in painting is the paint itself. In general, once an appropriate type of paint for a task at hand is chosen, there is little that one can do to change the cost. A limited exception to this, however, is that empty paint containers can sometimes be re-tasked and used to replace other containers that would have to be purchased. Thus, it is common in North America to encounter re-tasked empty 5-gallon paint containers around large construction sites.

There is a large body of prior art related to brush cleaning. One set of approaches is overnight brush soaking where the brushes are all held at a set, fixed height in a container. The bristles are not allowed to touch the bottom of the container, and the container is filled with the soaking solvent to an appropriate height. The following paragraphs discuss examples of this approach.

U.S. Pat. No. 1,979,241 by Albanese, et al. is for a Paintbrush Preserver having a special shaped container with a fixed-in-place, top edge of container supported brush rack. One disadvantage of this is the specialized shape of the necessary container. Another disadvantage, since the brush holding mechanism is fixed-in-place, is that the brushes must have similar dimensions and the solvent height must be adjusted to ensure that all of the bristles fully equally immersed.

U.S. Pat. No. 2,043,643 by Yenne is for a Paint Brush Keeper, one also having a special shaped container (termed a “keeper”) with an also fixed-in-place side-of-container supported brush rack. This approach suffers from the same disadvantages as Albanese, et al.

U.S. Pat. No. 2,278,650 by Drinkwater is for a Support For Brushes And Like Articles having a container with an internal fixed-in-place frame for holding articles. One disadvantage of this is the shape of the frame may limit the shape of the container. Another disadvantage is that the brushes must have similar dimensions and the solvent height must be adjusted to ensure that the bristles of all of the brushes are fully immersed.

U.S. Pat. No. 2,479,509 by Pichniarczyk is for a Paintbrush Holder having a container (also termed a “keeper”) with fixed-in-place side brush supports. One disadvantage of this is that the container must preferably be rectangular, e.g., a round container would be impractical. Another disadvantage is that the brushes must have similar dimensions, including each having a similarly located thru-hole (e.g., a hole to facilitate hanging the brush). Since it is common to use and to want to clean different sized brushes, and/or brushes from different manufactures, that may be dimensionally different or that may even lack a thru-hole in the brush handle, this may limit the utility of this approach. And another disadvantage, here as well, is that the solvent height must be adjusted to ensure that the bristles of all of the brushes are equally immersed.

U.S. Pat. No. 5,097,965 by Fher is for a Paint Brush Suspension Device having a container with a fixed-in-place top edge supported brush-clamping rack (termed “slats”). Unlike Pichniarczyk, the container here may be rectangular or round (e.g., a bucket or pail), but this approach otherwise generally suffers from the same disadvantages.

U.S. Pat. No. 5,829,603 by Martineau is for a Paint Utensil Cleaning Container having a container with a top edge supported cover with fixed height hooks for holding brushes. Here as well the brushes must have thru-holes to engage the hooks, and the disadvantages discussed above all generally apply.

Another set of approaches to prior art brush soaking has been to hold brushes at a limited variety of selectable heights in a container, and to fill the container to a necessary height with a soaking solvent. The following paragraphs discuss examples of this approach.

U.S. Pat. No. 8,286,790 by McBryar is for a Paint Brush Cleaning And Carrying Device having a container (e.g., a pail) with a top cover that includes a pins-in-holes mechanism to dangle brushes in a solvent. This approach is limited by the number of different heights of the holes, for instance, only sets of holes at two heights are shown. Another disadvantage is that the brushes require thru-holes as well as generally similar dimensions.

U.S. Pat. No. 4,607,752 by Sherrow is for a Paint Brush Cleaning Rack having a roughly rectangular footprint trough (i.e., a device that would have to go inside a container) with an external adjustable rack for holding brushes. Two approaches to clamping brush handles are taught. One uses straps of hook-and-loop fastener and the other uses a tie-wire arrangement. On their faces, these approach would appear to have brush height adjustability, however, the natures of these clamping mechanisms will tend to force brushes to similar heights because these approaches tend to grip the brushes all at the same, narrowest points on their handles.

U.S. Pat. No. 7,383,948 by Richardson is for a Paint Brush Cleaning Accessory having a container with a top edge supported cover that includes a spring clamping mechanism for holding brushes. On its face, this approach would also appear to have brush height adjustability, however, the spring based nature of the clamping mechanism here also tends to force brushes to the similar heights by clamping all at the narrowest points on their handles.

Yet another set of approaches to prior art brush soaking has been to hold brushes at widely selectable, different if necessary heights in a container, and to then fill the container to a necessary height with a soaking solvent. The following paragraphs discuss examples of this approach.

U.S. Pat. No. 2,310,533 by Lindell is for a Paint Brush Rack having a container with an external, adjustable side clamped rack for holding brushes. A disadvantage of this is that the container must preferably be rectangular and narrow, to efficiently use the volume of the container. Not using such a container can pose problems, since commonly used solvents are quite volatile and present sever fire hazard and explosion potential when solvent evaporates. Note, exacerbating this disadvantage in Lindell is that the rack and adjusting mechanism making fitting any kind of cover over the container to minimize evaporation quite difficult.

U.S. Pat. No. 2,472,001 by Buhoveckey is for a Paint Brush Protector having a container with an internal hooks-on-pulley (adjustable) mechanism for holding brushes. The container taught here is rectangular and has a tight fitting cover that is able to suppress solvent evaporation. However, the hooks-on-pulley mechanism is complicated. And here as well, the brushes used must have thru-holes, albeit, holes at different brush handle heights can be used.

U.S. Pat. No. 2,952,364 by Jacobson is for a Paint Brush Holder having a container with an internal bottom supported, center-rod adjustable-height rack of impaling pins for holding brushes. The container here appears to preferably be round, e.g., a bucket or pail, rather than rectangular. Again however, the brushes must have thru-holes where they are “impaled,” and here, holes at different brush handle heights cannot be used.

Finally, U.S. Pat. No. 5,097,967 by Sica is for a Paint Brush Cleaning, Drying, And Storage Container having a container with a top edge supported bar with adjustable height hooks for holding brushes. Here as well, the brushes must have thru-holes, albeit, ones at different brush handle heights can be used. The container can have a lid, but this cannot be fitted when the container is used for suspending brushes in a solvent. This lid can only be fitted on the container when it is used a storage chamber for brushes.

Accordingly, what are needed are improved methods and apparatus for paint brush soaking.

### BRIEF SUMMARY OF THE INVENTION

Accordingly, it is an object of the present invention to provide an improved method and apparatus for paint brush soaking.

Briefly, one preferred embodiment of the present invention is an apparatus for soaking brushes in a solvent. The apparatus includes a body of a surface material and a fill material, wherein the body is sufficiently buoyant to float on the surface of the solvent even when the apparatus holds at least one of the brushes. The apparatus also has a number of holding stations that extend through the body of the apparatus. Each such holding station includes a holding mechanism that is suitable to retain one of the brushes in its respective holding station.

Briefly, another preferred embodiment of the present invention is a process for soaking brushes that each have bristles. A container is provided that contains a quantity of solvent which is suitable for soaking the bristles of the brushes. At least one of the brushes is placed in a holding station that extends through a body of an apparatus, wherein the apparatus is sufficiently buoyant to float on the surface of the solvent when the apparatus holds at least one of the brushes. At least one of the brushes is held as desired in such a holding station with a holding mechanism. And the apparatus is floated on the surface of the solvent in said container, thereby particularly soaking the bristles of all of the brushes that are being held in the apparatus and in the solvent.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIGS. 1a-c are various views of a brush soak utensil in accord with the present invention;

FIG. 2 is a front cross section view of the utensil taken along section A-A of FIG. 1b;

FIG. 3 is a front cross section view of the utensil taken along section B-B of FIG. 1b;

FIG. 4 is a schematic representation, expanding on the front cross section view of FIG. 3;

FIGS. 5a-b are stylized views of two suitable holding mechanisms for use in the holding stations of the utensil;

FIG. 6 is a perspective view showing an alternate utensil that includes an alternate body, multiple brush holding stations, and an optional handle;

FIG. 7 is a schematic representation, expanding on the schematic representation in FIG. 4 and the front cross section view of FIG. 3; and

FIG. 8 is flow chart showing a process for soaking the bristles of brushes, in accord with the present invention.

In the various figures of the drawings, like references are used to denote like or similar elements or steps.

### DETAILED DESCRIPTION OF THE INVENTION

A preferred embodiment of the present invention is an improved system for paint brush soaking. As illustrated in the various drawings herein, and particularly in the views of the drawings, embodiment of the invention are depicted by the general reference characters 10, 100.

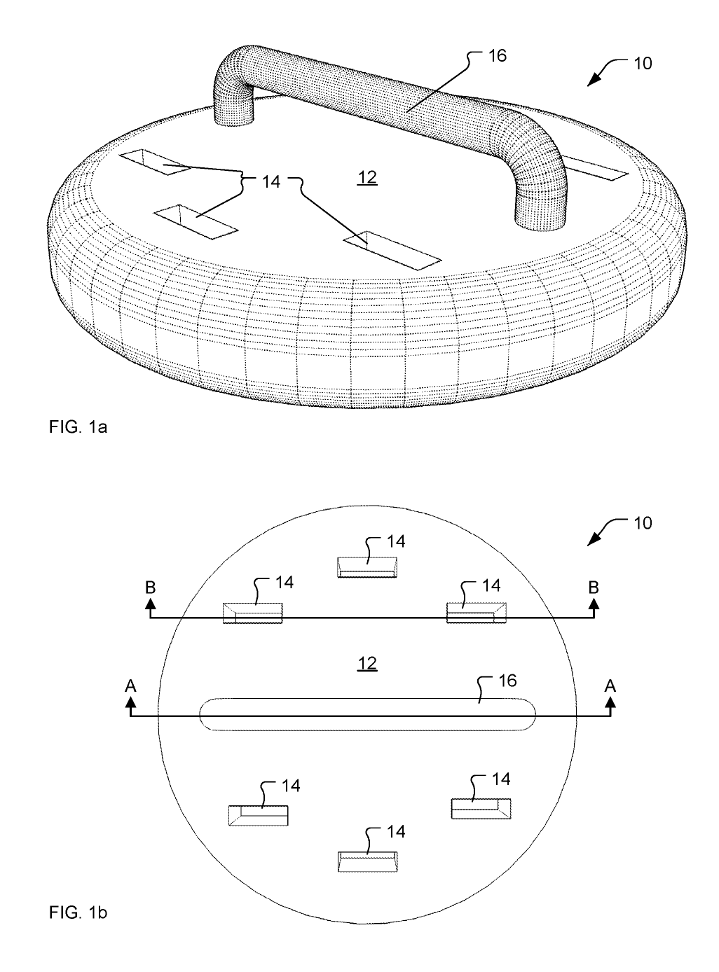

FIGS. 1a-c are various views of a brush soak utensil 10 in accord with the present invention. FIG. 1a is a perspective view showing how the utensil 10 includes a body 12, multiple brush holding stations 14, and a optional handle 16. FIG. 1b is a top plan view of the utensil 10 that additionally shows sections A-A and B-B, which are discussed presently with other figures. FIG. 1c is an alternate perspective view with hidden lines showing how the brush holding stations 14 penetrate clear through the body 12 of the utensil 10.

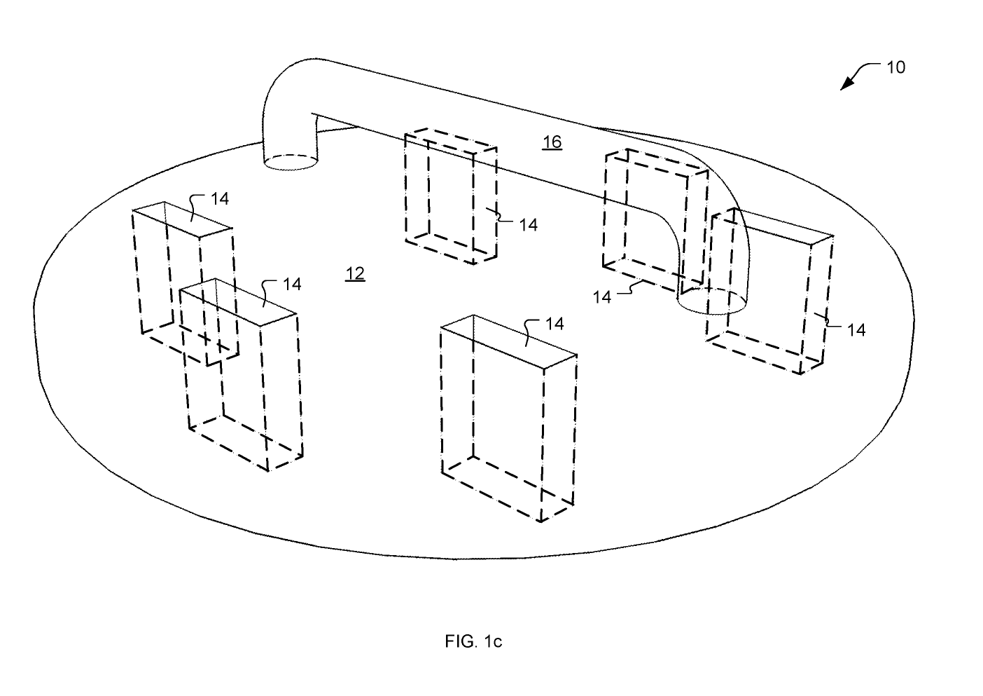

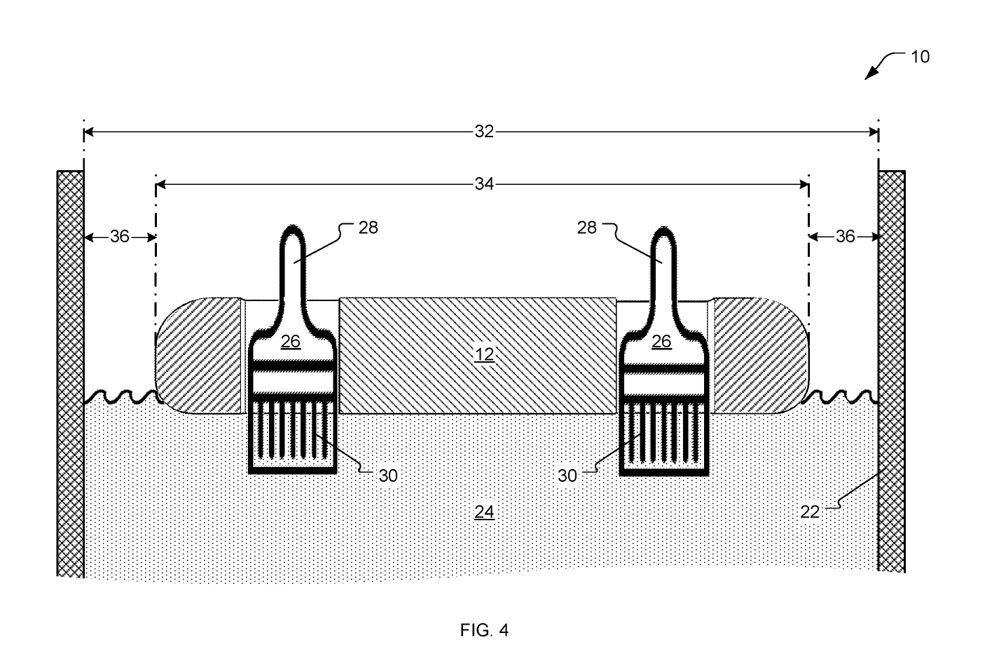

FIG. 2 is a front cross section view of the utensil 10 taken along section A-A of FIG. 1b. Here it can be seen that the body 12 has an outer surface material 18 and a fill material 20. The body 12 and the handle 16 here are shown as being of the same material, as stylistically depicted in the figure with similar cross-hatching. When the optional handle 16 is provided, as shown here, the fill material can all be the same, as also shown here. However, this is not a requirement. The surface material 18 and the fill material 20 may be any suitable materials that permit the utensil 10 to float when carrying brushes (see e.g., FIG. 4). Obviously, the surface material 18 should not be one that absorbs solvent type liquids, which might undermine floatation capability. Similarly, in the event the surface material 18 is abused and punctured, the fill material 20 preferably should also not be one that absorbs solvent liquid and undermines floatation. For example, the surface material 18 and the fill material 20 may be the same material, and that material may be a plastic. Alternately, the surface material 18 might be a hard plastic, even one so dense that it does not float, while the fill material 20 may be a floatable plastic foam material. Yet alternately, the surface material 18 might be a hard plastic, again even one so dense that it does not float, and the fill material 20 may simply be air. In this latter case, the surface material 18 should preferably be robust enough that punctures and the ingress of solvent into the region of the air fill material 20 is unlikely.

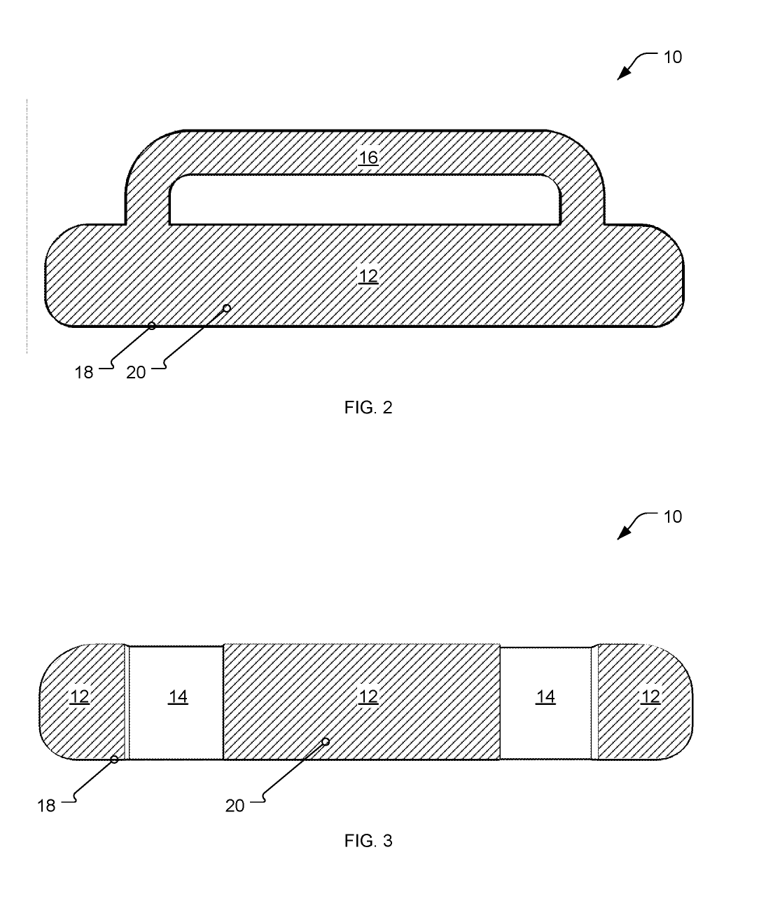

FIG. 3 is a front cross section view of the utensil 10 taken along section B-B of FIG. 1b, further showing how the holding stations 14 penetrate clear through the body 12.

FIG. 4 is a schematic representation, expanding on the front cross section view of FIG. 3, that conceptually depicts the utensil 10 in use. Here a container 22 contains a body of liquid solvent 24 upon which the utensil 10 is floating. The utensil 10 is holding two brushes 26, having brush handles 28 and bristles 30, in two of its holding stations 14. The bottom of the container 22 is not shown here, but it should be noted that the bristles 30 are not touching the bottom of the container 22, which is desirable when soaking brushes. The container 22 here does not have a cover, although it should be noted that a cover can easily be used because of the heights of the brush handles 28 of the brushes 26 are below where a cover would be fitted. While there is no limitation that the container 22 have any particular shape, other than one that retains the solvent 24, it should particularly be noted that the container 22 here might be a previously emptied conventional round 5-gallon paint container that has been re-tasked for brush soaking. If a cover is desired here, say, to minimize evaporation of the solvent 24, a conventional 5-gallon paint container cover can be re-tasked for that.

In FIG. 4 the internal width 32 of the container 22 and the external width 34 of the utensil 10 are shown as sufficiently different that there are clear side clearances 36. This emphasizes how the utensil 10 floats on the surface of the solvent 24. In other embodiments, however, the external width 34 of the utensil 10 may be chosen to be slightly less than the internal width 32 of an anticipated container 22, such as a conventional 5-gallon paint container. This will reduce the side clearances 36, and thus the amount of exposed upper surface area of the solvent 24 to help reduce evaporation.

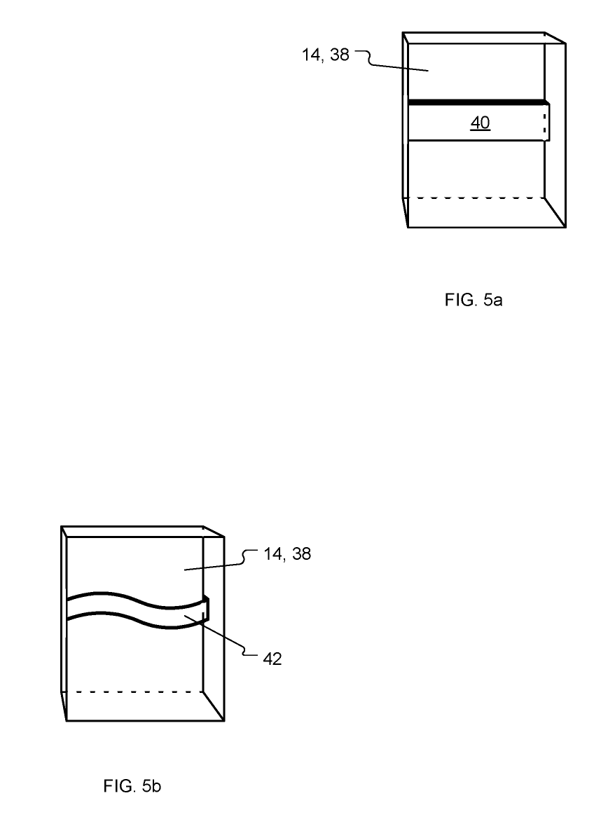

FIGS. 5a-b are stylized views of two suitable holding mechanisms 38 for use in the holding stations 14 of the utensil 10. In FIG. 5a a magnet 40 is shown located in the holding station 14 to retain a brush 26 at a height as desired in the holding station 14. Of course, for the magnet 40 to work, a portion of the brush 26 needs to be magnetically attractable. Most conventional brushes 26 have this feature, in the form of a metal heel or ferrule that holds the bristles 30 on the brush handle 28. In FIG. 5b a spring 42 is shown located in the holding station 14 there, to retain a brush 26 as desired in the holding station 14. This approach compress ably retains brushes 26 at whatever heights are desired.

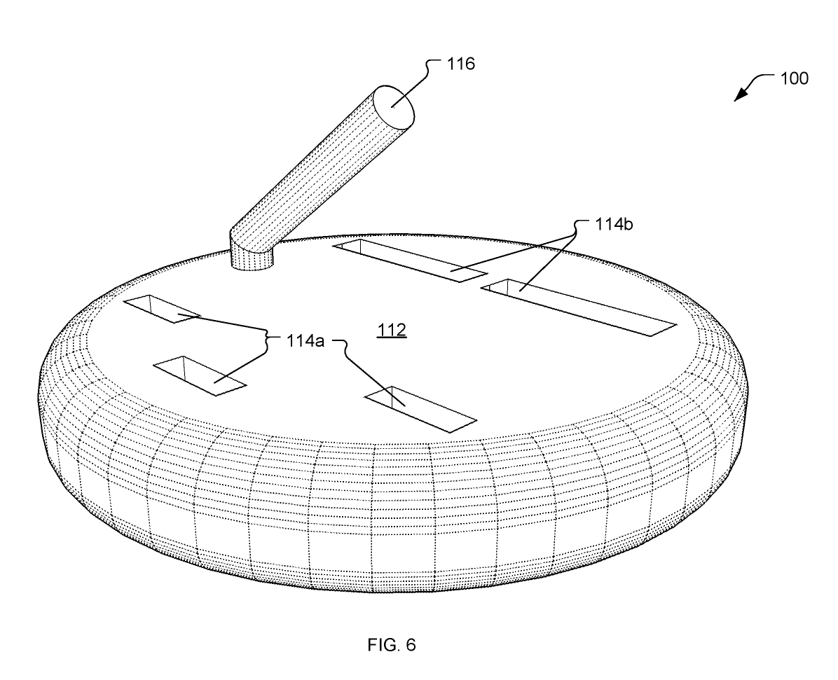

FIG. 6 is a perspective view showing an alternate utensil 100 that includes a body 112, multiple brush holding stations 114a-b, and an optional handle 116. The holding stations 114a-b here accommodate two widely different sizes of brushes and the handle 116 here serves to illustrate the variety that his optional component can take.

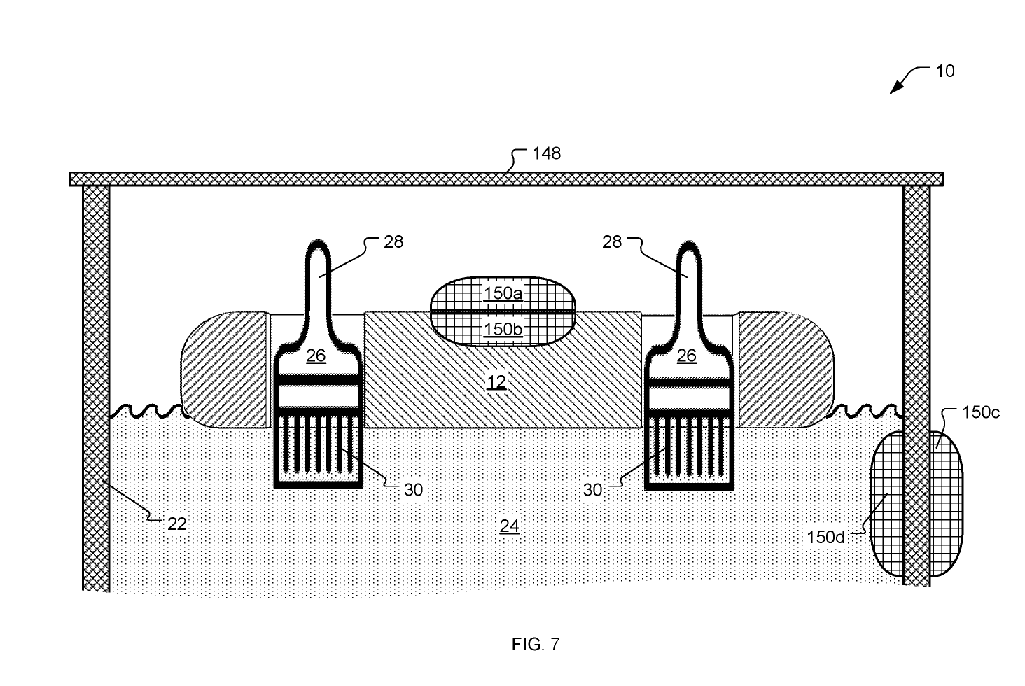

FIG. 7 is a schematic representation, expanding on the schematic representation in FIG. 4 and the front cross section view of FIG. 3. This conceptually depicts the utensil 10 with some additional options. As already noted, the container 22 can be sued with a cover, shown here as cover 148. The present invention can also be used with a vibrator 150a-d, wherein the vibrator 150a can be attached to the outside of the utensil 10, the vibrator 150b can be embedded in the body 12 of the utensil 10, the vibrator 150c can be attached to the outside of the container 22, the vibrator 150d can be placed in the solvent 24 inside the container 22, or the vibrator can be placed still elsewhere.

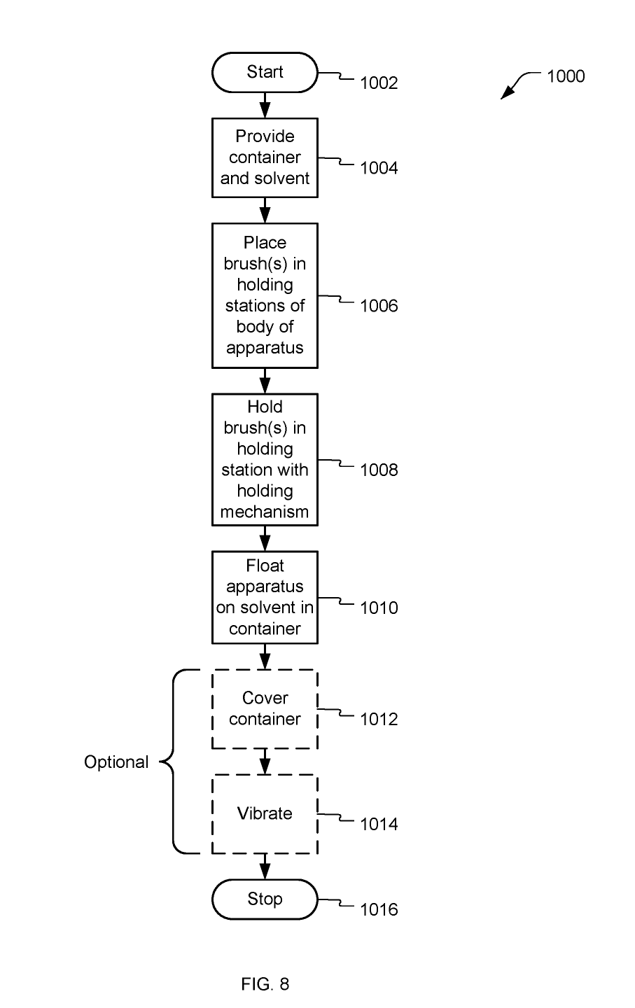

FIG. 8 is flow chart showing a process 1000 for soaking the bristles 30 of brushes 26, in accord with the present invention. The process starts with a general step 1002. In a step 1004 the container 22 and the solvent 24 are provided. In a step 1006 the brushes 26 to be soaked (i.e., cleaned) are placed in the holding stations 14, 114a-b of the body 12, 112 of the utensil 10, 100. In a step 1008 the brushes 26 are adjusted as desired (typically by height) in the holding stations 14, 114a-b with the holding mechanisms 38 (e.g., by magnets 40 or springs 42). In a step 1010 the utensil 10, 100 is floated on the surface of the solvent 24, thus holding the bristles 30 of the brushes 26 in the solvent 24. Optionally, in a step 1012 a cover 148 is placed on the container 22. Also optionally, in a step 1014 vibration is applied with a vibrator 150a-d. And finally, sometime later, typically but not necessarily overnight, in a general step 1016 the process 1000 stops.

While various embodiments have been described above, it should be understood that they have been presented by way of example only, and that the breadth and scope of the invention should not be limited by any of the above described exemplary embodiments, but should instead be defined only in accordance with the following claims and their equivalents.

What is claimed is:

1. An apparatus (10, 100) for soaking brushes (26) in solvent (24), comprising:
a body (12) having a surface material (18) and a fill material (20), wherein said body is sufficiently buoyant to float on a surface of the solvent when the apparatus holds at least one of the brushes; and
a plurality of holding stations (14) that extend through said body of the apparatus, wherein each said holding station includes a holding mechanism (38) that is suitable to retain one of the brushes in said respective holding station.

2. The apparatus of claim 1, wherein:
said surface material and said fill material of said body are a same material.

3. The apparatus of claim 1, wherein:
said surface material is a solid material and said fill material is a gaseous material.

4. The apparatus of claim 3, wherein:
said surface material is a solid material and said fill material is air.

5. The apparatus of claim 1, wherein:
said surface material is a solid plastic material and said fill material is a foam plastic material.

6. The apparatus of claim 1, wherein:
said body has an external width (34) that is less than an internal width (32) of a conventionally sized paint, glue, varnish, or like material container.

7. The apparatus of claim 1, wherein:
said plurality of holding stations includes at least two different sizes of holding stations.

8. The apparatus of claim 1, wherein:
said holding mechanisms of said plurality of holding stations each include a member of the set consisting of magnets (40) and springs (42).

9. The apparatus of claim 1, further comprising:
a handle (16) that is attached to said body, thereby facilitating a user handling the apparatus as desired.

10. The apparatus of claim 1, further comprising:
a vibration unit (150a-b) attached to or included in said body, thereby facilitating more rapid soaking and cleaning of the brushes.

11. A process (1000) for soaking brushes (26) each having bristles (30), comprising:
providing (1004) a container (22) containing a quantity of solvent (24) that is suitable for soaking the bristles of the brushes;
placing (1006) at least one of the brushes in a holding station (14) that extends through a body (12) of an apparatus (10, 100), wherein said apparatus is sufficiently buoyant to float on a surface of the solvent when the apparatus holds at least one of the brushes;
holding (1008) said at least one of the brushes in said holding station with a holding mechanism (38); and
floating (1010) said apparatus on said surface of said solvent in said container, thereby soaking particularly the bristles of all of the brushes then held in said apparatus in said solvent.

12. The process of claim 11, wherein said container includes a cover (148) and the process further comprises:
closing (1012) said container with said cover, thereby reducing evaporation of the solvent.

13. The process of claim 11, wherein said body includes a handle (16) and the process further comprises:
handling said floating of said apparatus by a user of the process grasping said handle.

14. The process of claim 11, wherein said holding mechanism includes a magnet (40) and wherein:
said holding of said at least one of the brushes in the holding station is magnetically holding.

15. The process of claim 11, wherein said holding mechanism includes a spring (42) and wherein:
said holding of said at least one of the brushes in the holding station is compressible holding.

16. The process of claim 11, further comprising:
during said floating said apparatus on said surface of said solvent in said container, vibrating (1014) either or both of the brushes or said solvent.

17. The process of claim 16, wherein:
said vibrating is of the brushes by a vibration unit (150a-b) that is attached to said apparatus or included in said body of said apparatus.

18. The process of claim 16, wherein:
said vibrating is of the solvent by a vibration unit (150c-d) that is attached to or contained in said container.
